(19) United States
(12) Patent Application Publication
(10) Pub. No.: US 2026/0365067 A1
(43) Pub. Date: Nov. 19, 2026

(54) SYSTEM AND METHOD FOR ADAPTIVE CHARGING A BATTERY PACK OF A VEHICLE

(71) Applicant: TVS Motor Company Limited, Nungambakkam, Chennai (IN)

(72) Inventors: Chaitanya Rajendra Zanpure, Chennai (IN); Rahul Kaushik, Chennai (IN); Krishna Kumar Ramakrishna Pandian, Chennai (IN); Dachepalli Dileep Kumar, Chennai (IN); Ramalingam Velmurugam, Chennai (IN)

(73) Assignee: TVS Motor Company Limited, Nungambakkam, Chennai (IN)

(21) Appl. No.: 19/487,835

(22) PCT Filed: Aug. 22, 2024
(86) PCT No.: PCT/IN2024/051533

§ 371 Date: Nov. 25, 2025

(30) Foreign Application Priority Data
Aug. 22, 2023 (IN) 202341056191

(51) Int. Cl. B60L 53/64; B60L 53/10

(52) U.S. Cl. CPC B60L 53/64; B60L 53/11; B60L 2260/54

(57) ABSTRACT

A system for adaptive charging a battery pack of a vehicle includes a control unit disposed in the vehicle and that is configured to: receive information pertaining to operating parameters of the vehicle from one or more sensors, information pertaining to grid parameters of a charging unit, and one or more user parameters from a user of the vehicle, determine operating parameters of the vehicle based on the information pertaining to the operating parameters of the vehicle, determine grid parameters of the charging unit based on the information pertaining to the grid parameters of the charging unit, and determine a rate of charging of the battery pack based on at least one of the operating parameters of the vehicle, the grid parameters, and the one or more user parameters of the user.

### FIELD OF THE INVENTION

Present invention relates to a system and a method for adaptive charging a battery pack of a vehicle. More particularly, the present invention relates to the system and the method for adaptive charging the battery pack of the vehicle based on inputs received from at least one of a user of the vehicle, the battery pack and a charging unit.

### BACKGROUND OF THE INVENTION

In recent past, one of the major innovations in the field of Electrical and Electronics is in the field of battery charging. The focus is on the effective methods for charging a battery while making sure that the battery has a long life. The conventional development in this field is focused predominantly on fast charging or quick charging of the battery. Such a development is towards vehicles, particularly electric vehicles, in order to reduce idle time or downtime of the electric vehicles during charging of the battery.

However, one of the major drawbacks of fast charging is the reduction in battery life. This is due to the fact that, fast charging can adversely affect the life of the battery, due to factors such as an increase in battery temperature beyond a critical point, loads connected to the battery and the like. Such a scenario may require a user to change the battery frequently or prematurely than when the battery is charged correctly.

Further, the user may leave the battery being charged for a long period of time, say overnight. Such a situation may cause the battery to be charged unnecessarily, even when the battery may have been fully charged, leading to degradation in life of the battery, which is undesirable.

Additionally, there are several technical problems and challenges associated with fast charging such as heat generation and thermal Management caused during fast charging. At this scenario, the battery is subjected to increased heat generation within cells of the battery which degrades the performance of the battery, thereby reducing the battery lifespan and pose safety risks. Further, frequent fast charging of the battery can accelerate the degradation of cells of the battery leading to reduced capacity and shorter overall battery lifespan. As such, managing the trade-off between fast charging and battery longevity is a significant challenge. Also, fast charging often involves higher voltage and current levels, which can create stress on the cells of the battery and associated components. Thus, maintaining proper voltage and current regulation while preventing overcharging or over-discharging is crucial. Additionally, during fast charging, the voltage of the power supply can sag due to the high current demand. Such a scenario can lead to power quality issues and potentially affect the charging speed and efficiency.

Furthermore, some battery chemistries used in electric vehicles are more suitable for fast charging than others. Lithium-ion batteries, for example, can experience more pronounced issues with heat and degradation during rapid charging. Research into new battery chemistries and materials that can withstand fast charging while maintaining performance is ongoing. Moreover, electrical infrastructure, including power grids and charging stations, may not always be capable of providing the necessary high-power levels for fast charging without causing grid stability issues or requiring expensive upgrades. Further, while fast charging stations are becoming more common, their availability can still be limited in certain areas, potentially leading to long waiting times during peak usage.

In view of the above, there is a need for a system and a method for adaptive charging a battery pack of a vehicle which addresses one or more limitations stated above.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 is a schematic view of a block diagram of a system for adaptive charging of a battery pack of a vehicle, in accordance with an exemplary embodiment of the present invention.

FIG. 2 is a flow diagram of a method for adaptive charging of the battery pack of the vehicle, in accordance with an exemplary embodiment of the present invention.

### SUMMARY OF THE INVENTION

In one aspect, a system for adaptive charging a battery pack is disclosed. The system comprises a control unit disposed in the vehicle. The control unit being configured to receive information pertaining to operating parameters of the vehicle from one or more sensors, information pertaining to grid parameters of a charging unit and one or more user parameters from a user of the vehicle. The control unit then determines operating parameters of the vehicle based on the information pertaining to the operating parameters of the vehicle, and grid parameters of the charging unit based on the information pertaining to the grid parameters of the charging unit. A rate of charging of the battery pack is then determined by the control unit based on at least one of the operating parameters of the vehicle, the grid parameters and the one or more user parameters of the user.

In an embodiment, the control unit is configured to create, a user profile of the user based on at least one of, the information pertaining to the operating parameters of the vehicle and the grid parameters and control, the rate of charging of the battery pack based on the user profile.

In an embodiment, the control unit is configured to determine, an approximate distance of a trip upon receiving a destination location of the trip from the user, and determine, the rate of charging of the battery pack upon receiving the destination location of the trip.

In an embodiment, the control unit is configured to one of determine, topography of a route based on the route considered by the user for completing the trip and predict, topography of the route considered by the user for completing the trip, based on a previous trip of the user to the destination location.

In an embodiment, the control unit is configured to select the rate of charging of the battery pack as a fast charging during a non-peak consumption hour.

In an embodiment, the control unit is configured to suggest, a time for one of charging the battery pack and schedule charging of the battery pack.

In an embodiment, the control unit is configured to control the rate of charging of the battery pack based on a power outage history.

In another aspect, a method for adaptive charging the battery pack of the vehicle is disclosed. The method comprises the control unit being configured to receive, the information pertaining to operating parameters of the vehicle from one or more sensors, the information pertaining to grid parameters of a charging unit and the one or more user parameters from a user of the vehicle. The control unit then determines operating parameters of the vehicle based on the information pertaining to the operating parameters of the vehicle, and the grid parameters of the charging unit based on the information pertaining to the grid parameters of the charging unit. The rate of charging of the battery pack is then determined by the control unit based on at least one of the operating parameters of the vehicle, the grid parameters and the one or more user parameters of the user.

### DETAILED DESCRIPTION OF THE INVENTION

The present invention provides a system and a method for adaptive charging a battery pack of a vehicle. The present invention is configured for adaptive charging the battery pack of the vehicle based on at least one of operating parameters of the vehicle, grid parameters of a charging unit and user parameters received from a user of the vehicle. The vehicle in the context of the present invention may be a two-wheeled vehicle, a three-wheeled vehicle or a multi-wheeled vehicle as per requirement. In the present embodiment, the vehicle may be an electric two-wheeled vehicle.

In the context of the present invention, the term “adaptive charging” pertains to adjustable charging of the battery pack based on information received by the system.

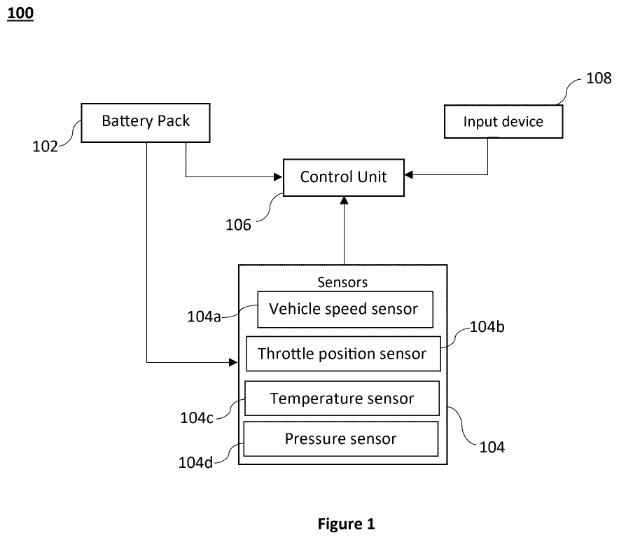

FIG. 1 is a schematic view of a block diagram of a system 100 for adaptive charging of a battery pack 102 of a vehicle, in accordance with an exemplary embodiment of the present invention. The system 100 is adapted to provide an efficient charging mechanism for the battery pack 102 of the vehicle (not shown), while enhancing health of the battery pack 102. Additionally, the system 100 ensures a new charging behavior to a user such as a rider of the vehicle, enabling healthy charging of the battery pack 102.

In an embodiment, the vehicle is a two-wheeled vehicle, a three-wheeled vehicle or a multi-wheeled vehicle as per requirement. In the present embodiment, the vehicle may be an electric two-wheeled vehicle.

The system 100 comprises one or more sensors 104 disposed in the vehicle. The one or more sensors 104 are adapted to procure information pertaining to operating parameters of the vehicle. In an embodiment, the one or more operating parameters of the vehicle comprises vehicle parameters and battery parameters. The vehicle parameters comprise a speed of the vehicle, an acceleration of the vehicle, a braking of the vehicle and an ambient temperature around the vehicle. The battery parameters comprise a cell temperature of the battery pack, a cell-to-cell imbalance, a State of Health (SOH) of the battery pack 102 and a State of Charge (SOC) of the battery pack 102 and back-to-back imbalance maximum charge current with which the battery pack 102 is charged.

In an embodiment, the one or more operating parameters of the vehicle comprises vehicle parameters and battery parameters. The vehicle parameters comprise the speed of the vehicle, an acceleration of the vehicle, a braking of the vehicle and an ambient temperature around the vehicle. The battery parameters comprise a cell temperature of the battery pack 102, a cell-to-cell imbalance, a State of Health (SOH) of the battery pack 102 and a State of Charge (SOC) of the battery pack 102 and back-to-back imbalance maximum charge current with which the battery pack 102 is charged.

In an embodiment, the one or more sensors 104 comprises a vehicle speed sensor 104a, a throttle position sensor 104b, a temperature sensor 104c and a pressure sensor 104d. Accordingly, the vehicle speed sensor 104a is disposed onto one of a wheel (not shown) of the vehicle. The vehicle speed sensor 104a is adapted to procure information pertaining to the speed of the vehicle. The vehicle speed sensor 104a is adapted to procure information pertaining to the speed of the vehicle based on rotation of the wheel of the vehicle. The throttle position sensor 104b is disposed on a handlebar of the vehicle and is adapted to procure information pertaining to actuation of a throttle member (not shown) of the vehicle. As such, the throttle position sensor 104b is adapted to procure information pertaining to a percentage of throttle opening of the throttle member. Further, the temperature sensor 104c is disposed in the battery pack 102 of the vehicle and is adapted to procure information pertaining to the cell temperature of the battery pack 102. Additionally, the pressure sensor 104d is disposed in the battery pack 102 and is adapted to determine pressure within the battery pack 102.

The system 100 also comprises a control unit 106 communicably coupled to the one or more sensors 104. The control unit 106 is adapted to receive the information procured by the one or more sensors 104 pertaining to the operating parameters of the vehicle. Additionally, the control unit 106 is adapted to receive one or more user parameters (hereinafter selectively referred to as ‘user parameters’) from the user, wherein the control unit 106 is adapted to adjust the rate of charging of the battery based on the user parameters provided by the user and/or the information procured by the one or more sensors 104.

In an embodiment, the user parameters comprise the user providing details pertaining to a start time of a trip and an approximate distance of the trip. In an embodiment, the approximate distance is provided by user by either inputting the distance of the trip or by inputting a destination location of the trip. The control unit 106 upon receiving the destination location of the trip is adapted to determine the approximate distance of the trip. Accordingly, the control unit 106 is adapted to determine the rate of charging of the battery pack 102 for ensuring completion of the trip by the user. As an example, the user may directly input to the control unit 106 that he intends to travel a distance of 25 miles or may input a location say “silk board bus stand” to the control unit 106. The control unit 106 determines the distance based on the location of the user to the “silk board bus stand”. Accordingly, the approximate distance of the trip is determined by the control unit 106.

In an embodiment, the control unit 106 is also adapted to predict topography of a route considered by the user for completing the trip. The control unit 106 is adapted to determine the topography of the route based on a route considered by the user for completing the trip. In an embodiment, the control unit 106 may predict the topology based on a previous trip of the user to the same location. Based on the topology, the control unit 106 may determine the distance and/or a charging level in the battery pack 102 required for completing the trip or for reaching the destination selected by the user.

Further, in order to receive inputs from the user, the control unit 106 is communicably coupled to an input device 108. The input device 108 is capable of receiving inputs from the user of the vehicle. In an embodiment, the input device 108 is an infotainment system of the vehicle. The input device 108 may be mounted on the handlebar of the vehicle. Also, the input device 108 may be oriented towards the user of the vehicle for ease of accessing and/or viewing the information depicted in the infotainment system. In an embodiment, the user provides the user parameters to the control unit 106 through the infotainment system. In an embodiment, the input device 108 is provided with a keypad (not shown) for receiving the inputs from the user. The keypad may be provided proximally to a holding portion (not shown) of the handlebar and thus the user can easily interact with the infotainment system for providing the user inputs. In another embodiment, the input device 108 may comprise a touch screen interface for receiving inputs from the user. In another embodiment, the input device 108 may comprise an audio interface (not shown) for interacting with the user through audio inputs. Accordingly, the user can orally provide the user parameters to the input device 108.

Further, the control unit 106 also receives information pertaining to grid parameters of a charging unit (not shown) or a charging station (not shown). Thus, the system 100 or the control unit 106 not only considers information pertaining to the user behavior and/or the vehicle information but also considers information pertaining to the charging station or the charging grid that the user employs for charging the battery pack 102. In other words, the system 100 or the control unit 106 considers not only the user behavior and/or the vehicle behavior, but also the charging behavior for determining the rate of charging ideal for optimally charging the battery pack 102, while improving life of the battery pack 102.

In an embodiment, the grid parameters received by the control unit 106 comprise information pertaining to charging of the battery pack 102 during a peak consumption hour. In an embodiment, the grid parameters also comprise information pertaining to a scheduled power outage in the charging grid or the charging station.

The control unit 106 upon receiving the information pertaining to the operating parameters of the vehicle and/or the grid parameters is adapted to determine a rate of charging of the battery pack 102. Thus, the control unit 106 is adapted to provide an adaptive rate of charging the battery pack 102 based on a usage pattern of the vehicle, thereby enhancing health of the battery pack 102. Moreover, the control unit 106 adjusts the charging process of the battery pack 102 based on aforesaid factors for improving life of the battery pack 102, while saving charging costs without compromising the end charging result.

Further, the control unit 106 is adapted to create a user profile (not shown) of the user based on the information pertaining to the operating parameters of the vehicle and/or the grid parameters. The control unit 106 is adapted to control or adjust the rate of charging of the battery pack 102 based on the user profile. In an embodiment, the user profile corresponds to a charging profile of the vehicle. In other words, the control unit 106 creates the user profile which includes instructions or directives pertaining to charging the battery pack 102 of the vehicle. Further, based on the grid parameters, the control unit 106 is adapted to customize the user profile such that the charging of the vehicle is carried out in such a way that fast charging is used only during a non-peal consumption hour. The control unit 106 based on the information pertaining to the scheduled power outage is adapted to suggest a time for charging or schedule the charging of the battery pack 102.

In an embodiment, the control unit 106 is adapted to execute one or more Machine Learning (ML) techniques for creating the user profile or the charging profile for the battery pack 102 based on the information pertaining to the operating parameters of the vehicle and/or the grid parameters. In an embodiment, the control unit 106 is adapted to perform predictive analytics by utilizing historical data to anticipate power outages, grid conditions and behavior of the user. Based on the historical data the control unit 106 is adapted to adjust the rate of charging to prevent disruptions during charging. In another embodiment, the control unit 106 is adapted to execute adaptive techniques by taking into account all the information pertaining to operating parameters of the vehicle, the user preferences and grid parameters to adapt the rate of charging or the charging profile for the battery pack 102 of the vehicle. The charging profile might include slowing down or speeding up charging rates or pausing charging during a grid instability or adjusting charging start time based on a power outage history.

In an embodiment, the control unit 106 is adapted to execute one or more Artificial Intelligence (AI) techniques based on the information pertaining to the operating parameters of the vehicle and the grid parameters for predicting vehicle usage patterns. In an embodiment, the control unit 106 is adapted to execute a time series analysis or one or more regression models for predicting the vehicle usage patterns.

In an embodiment, the control unit 106 by executing AI and/or ML techniques for determining personalized charging profiles, predictive usage patterns, safety measures, and real-time monitoring for dynamic charging of the vehicle. In an embodiment, the control unit 106 is adapted to analyze historical charging patterns, user preferences, health of the battery pack 102, and vehicle condition data to determine optimal charging profiles for each user. Accordingly, the control unit 106 may adjust the charging rates, start times, and SoC targets to meet the user's needs while considering battery health and grid conditions. In an embodiment, the control unit 106 is adapted to utilize historical data, calendar events, weather forecasts, and user inputs. The control unit 106 through the AI and/or ML models can predict future vehicle usage patterns. Such a situation helps in adapting the charging profile to ensure the vehicle is adequately charged for upcoming trips.

In an embodiment, the control unit 106 through one or more AI and/or ML techniques monitors grid stability. As such, if a power outage is detected, the control unit 106 is adapted to pause charging temporarily and resume when power is restored. Also, the control unit 106 can dynamically adjust the charging profile when the user changes the trip plan. The adjustment to the charging profile could involve accelerating or slowing down charging based on the new departure time. In an embodiment, the control unit 106 through the one or more AI and/or ML techniques can analyze real-time grid data to identify peak and non-peak hours. Accordingly, the charging profile can be adjusted to minimize load during peak times, reducing stress on the grid.

In an embodiment, the control unit 106 through one or more AI and/or ML techniques is adapted to continuously monitor charging progress, battery status, and grid conditions in real-time. This information can be displayed through the UI in the infotainment system, showing the estimated time to achieve a full charge and providing live updates on the charging process.

In an embodiment, the control unit 106 through one or more AI and/or ML techniques is adapted to predict vehicle usage patterns depending on the complexity of the predictions and the available data. In an embodiment, the time series analysis is employed for predicting usage patterns based on historical data. Techniques like ARIMA (Auto-Regressive Integrated Moving Average) or more advanced models like LSTM (Long Short-Term Memory) neural networks can be used to capture temporal dependencies and predict usage patterns over time.

In an embodiment, regression models are used to predict specific usage metrics, such as the distance traveled per day by the vehicle or the frequency of trips in the vehicle. Linear regression, polynomial regression, or support vector regression are examples of techniques that can model relationships between input features and usage patterns.

In an embodiment, the control unit 106 through one or more AI and/or ML techniques is capable of predicting categorical outcomes, like whether the user will take short trips or long trips. In an embodiment, clustering techniques like K-means clustering can be employed by the control unit 106, for identifying distinct vehicle usage patterns based on different features like time of day, trip distance, or purpose. Once clusters are formed, predictions can be tailored to each cluster.

In an embodiment, the control unit 106 employs deep learning models such as feedforward neural networks or convolutional neural networks (CNNs), for identifying and learning complex patterns from large amounts of data pertaining to the operating parameters of the vehicle, the grid parameters and the user preferences. The deep learning models enable the control unit 106 to predict usage patterns that involve multiple features and interactions between the vehicle, the user and the charging grid.

In an embodiment, for more complex scenarios, the control unit 106 may employ reinforcement learning to predict usage patterns by allowing the AI to interact with an environment (simulated or real) and learn optimal decisions over time. In an embodiment, the control unit 106 is adapted to employ ensemble models and techniques like Gradient Boosting or XGBoost to combine the predictions of multiple models for improving accuracy and handling noise in the data received.

In an embodiment, for accurate predictions, the control unit 106 may employ Principal Component Analysis (PCA). Such a technique enhances the quality of input data, thereby ensuring accuracy in the prediction.

In an embodiment, while implementing the AI and/or ML techniques through the control unit 106, the control unit 106 requires labeled historical data that captures various aspects of vehicle usage (time, distance, purpose, etc.) and such data will be used for training. The training data is essential to preprocess the data, tune the model parameters, and validate the predictions to ensure accuracy and reliability.

In an embodiment, the control unit 106 is adapted to create a personalized charging profile for each user by considering various factors such as a power outage, a vehicle condition, a state of the grid, the State of Health (SoH), and the State of Charge (SoC).

In an embodiment, the control unit 106 is adapted to detect power outages in charging stations and/or charging grids. Based on the power outages detected, the control unit 106 adjusts the charging profile accordingly. When power is restored, the control unit 106 resumes charging based on the user's preferences and the remaining charging time.

In an embodiment, the control unit 106 regularly assesses a condition (or health) of the vehicle and battery pack 102. In an embodiment, the control unit 106 is adapted to assess condition of the vehicle based on the operating parameters of the vehicle determined through the one or more sensors 104. In an embodiment, the control unit 106 is adapted to assess condition of the battery pack 102 based on information provided by sensors (not shown) in the battery pack 102. If the State of Health of the battery pack 102 is not optimal, the charging profile may be adjusted by the control unit 106 to be gentler, reducing stress on the battery pack 102.

In an embodiment, the control unit 106 is adapted to consider the desired State of Charge (SOC) for the user's next trip. Accordingly, the control unit 106 is adapted to adjust the charging profile to ensure that the vehicle is adequately charged, considering factors like trip distance, charging infrastructure availability at the next destination, in transit, and user preferences.

In an embodiment, the control unit 106 is adapted to monitor a state of the charging grid in real-time. If the charging grid is experiencing high demand or instability, the charging profile may be adjusted to minimize load during peak hours or grid stress.

In an embodiment, the control unit 106 is adapted to allow users to set preferences for charging, such as preferred slow/fast charging times (during nighttime, during parking at office hours, etc.), desired SoC at departure, and battery health preservation settings as per feasibility and requirement.

In an embodiment, the control unit 106 is configured to adapt the charging profile based on the one or more operating parameters of the vehicle. The adaptation of the charging profile may involve slowing down or speeding up the charging rates, pausing charging during grid instability, or adjusting the charging start time based on power outage history as per requirement.

In an embodiment, the control unit 106 is adapted to continuously monitor battery charging behavior and/or the charging grid conditions. If the charging grid stability is compromised or the battery pack 102 exhibits unusual behavior, the control unit 106 is adapted to adjust the charging rate accordingly for preventing damage to the battery pack 102. In an embodiment, the control unit 106 is adapted to utilize renewable energy sources when available to charge the vehicle thereby optimizing environmental impact (i.e. by reducing carbon footprint) and costs.

In an embodiment, the control unit 106 is adapted to utilize historical data and predictive analytics to anticipate power outages, grid conditions, and user behavior. Accordingly, the control unit 106 is capable of proactively adjusting the charging profile to prevent disruptions during the charging. In an embodiment, the control unit 106 allows the users to override preferences, in case of sudden changes or personal preferences.

In an embodiment, the control unit 106 is adapted to implement communication between the vehicle, the charging station, and the charging grid to ensure the charging profile is dynamically adjusted as conditions change. In an embodiment, the control unit 106 is adapted to remotely control and monitor the charging profile of the vehicle. Accordingly, an alert can be sent to inform the user of any changes to the charging profile due to unforeseen circumstances. In an embodiment, the control unit 106 is adapted to ensure that the data of the user is handled securely, and privacy concerns are addressed when collecting information for personalized charging profiles.

In an exemplary embodiment, say the user named “USER-1” has preferences and information such as, a desired SoC at departure 80%, a planned trip at 9:00 AM, tomorrow for 50 miles, a charging station being available at destination, a SOH of the battery pack 102 being good, a preferred charging start time being 11:00 PM, a time-of-use electricity pricing program being present Yes, wherein the fares for charging the battery pack 102 are lower between 10:00 PM to 6:00 AM and weather forecast being clear skies. Based on this information, the control unit 106 creates a personalized charging profile for “USER-1”, wherein the control unit 106 predicts that “USER-1” requires around 30 kWh to cover the 50-mile trip tomorrow. Also, the control unit 106 notes that since the charging station is available at the destination, the control unit 106 decides to charge the battery to around 85% SoC (slightly higher than the desired 80%) to ensure enough energy for unexpected detours during the trip. Further, given the lower electricity rates from 10:00 PM to 6:00 AM, the control unit 106 schedules charging of the battery pack 102 to start at 11:00 PM, allowing “USER- 1” to take advantage of the cheaper electricity. Additionally, the charging rate is adjusted to be moderate, considering health of the battery pack 102 of the USER-1's, in order to preserve longevity of the battery pack 102. Also, the control unit 106 monitors real-time grid conditions and avoids peak hours, ensuring that charging of the battery pack 102 doesn't strain the grid during periods of high demand. Further, the control unit 106 ensures that the charging process is set to pause during USER-1's planned departure time (i.e. at 9:00 AM tomorrow) to allow for last-minute adjustments if needed. Furthermore, the control unit 106 checks the weather forecast and predicts that the battery pack 102 will perform efficiently due to clear skies and moderate temperatures.

Based on the personalized user profile created for the “USER-1”, the control unit 106 charges the battery from 11:00 PM to around 85% SoC by 9:00 AM (the next day) in a moderate rate, providing enough energy for the planned 50-mile trip while considering cost savings, battery health, and grid stability. In an embodiment, the control unit 106 will also take into consideration the usage of the vehicle by multiple users within a family and all usage requirement of the vehicle is determined based on the usage requirement of all the users and/or family members.

In an embodiment, the preferences and/or information pertaining to the user may be predictively determined by the control unit 106 or maybe directly provided by the user directly using a User Interface provided in the input device 108. In an embodiment, the control unit 106 determines the preferences and/or information pertaining to the user from calendar events etc. of the user and/or the family of the user.

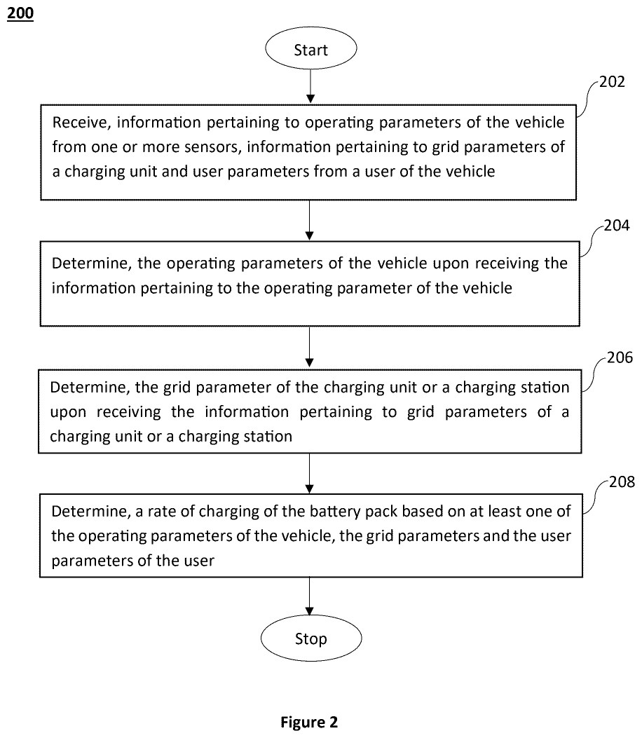

FIG. 2 is a flow diagram of a method 200 for adaptive charging the battery pack 102 of the vehicle, in accordance with an exemplary embodiment of the present invention.

At step 202, the control unit 106 is adapted to receive the information procured by the one or more sensors pertaining to the operating parameters of the vehicle. Subsequently, the control unit 106 receives information pertaining to grid parameters of the charging unit or the charging station. Thereafter, the control unit 106 receives the one or more user parameters from the user of the vehicle.

At step 204, the control unit 106 determines the operating parameters of the vehicle and the grid parameters at step 206 as mentioned in description of FIG. 1. Subsequently, the control unit 106 is adapted to determine the rate of charging of the battery pack 102 (as explained in description pertaining to FIG. 1) at step 208, based on at least one of the operating parameters of the vehicle, the grid parameters and the preferences of the user, thereby ensuring efficient and safe charging of the battery pack 102.

Advantageously, the present invention provides the system that is adapted to provide an efficient charging mechanism for the battery pack 102 of the vehicle, while enhancing health of the battery pack 102. Additionally, the system ensures a new charging behavior to a user such as a user, enabling benefit of healthy charging of the battery pack 102. Also, the system creates a personalized profile based on user preferences and vehicle parameters, enhancing the overall efficiency, longevity and user experience of both the vehicle and the charging infrastructure, thereby enabling adaptive charging to the battery pack 102 based on user behavior and requirement. Furthermore, the system ensures inexpensive charging to the user by considering the peak hour timing of the charging grid. Further, the system creates the personalized charging profiles by taking into account the specific needs and usage patterns of individual EV owners, which optimizes the charging process to avoid peak demand times thereby reducing stress on the power grid and optimizing charging efficiency.

Additionally, the system creates the dynamic charging profiles that considers factors such as battery chemistry, temperature and charge rate limits to extends the lifespan of the battery by tailoring the charging process to the battery's characteristics thereby minimizing the battery degradation resulting in Battery Longevity.

Further, the system creates personalized charging profiles which enables load balancing by distributing charging demands over different time periods thereby preventing grid overload during peak usage hours and minimizing the need for costly grid infrastructure upgrades. Also, the system creates personalized charging profiles which can be configured to align with renewable energy generation such as solar or wind power which results in the vehicle getting charged when renewable energy sources are producing electricity thereby maximizing the use of clean energy and reducing the greenhouse gas emissions through Renewable Energy Integration.

Furthermore, the system creates personalized charging profile which be configured to integrate demand response programs which allows the vehicle to charge during the periods of low demand or when the electricity prices are lower thereby benefiting the user of the vehicle and the grid by reducing the energy costs through Demand Response Integration. Also, the system creates personalized charging profiles which can be configured to incorporate smart algorithms that adapt to real-time conditions such as grid congestion, energy prices and vehicle availability to ensure the most efficient and cost-effective charging strategy through integration of Smart Charging Algorithms.

Additionally, the system creates personalized charging profiles which can be configured to monitor battery health in real time and adjust charging rates accordingly and if anomalies such as high internal resistance or cell imbalance are detected, the charging profile can be modified thereby mitigating potential damage through Battery Health Monitoring. Also, the system creates personalized charging profiles which can be configured to match the user's daily routines, ensuring that the vehicle is sufficiently charged when needed without unnecessary delays thereby enhancing the user experience and reduces anxiety about range. Further, the system creates personalized charging profiles which can be configured to create the dynamic charging profile through which the vehicle owners can remotely monitor and control their vehicle's charging status, thereby allowing them to adjust charging setting on the fly using mobile applications or smart home devices, increase the user's convenience. Furthermore, the system creates personalized charging profiles which can be configured to adapt to individual vehicle charging profiles, thereby providing optimal charging rate based on the state of charge, temperature, and other factors of the battery pack 102 thereby minimizing the risk of overcharging and overheating through charging stations.

Furthermore, the system creates collects data from personalized charging profiles to provide valuable insights to the vehicle manufacturers, utilities and policymakers thereby enabling them to refine vehicle designs, improve grid management strategies and plan for future charging infrastructure needs. Also, the system provides for the dynamic charging of a battery based on personalized profiles enabling a more intelligent and efficient use of energy resources while extending the lifespan of EV batteries thereby aligning the charging process with user preferences and grid conditions to promote a sustainable and integrated approach to electric mobility.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable storage medium” should be understood to include tangible items and exclude carrier waves and transient signals, i.e., be non-transitory. Examples include random access memory (RAM), read-only memory (ROM), volatile memory, non-volatile memory, hard drives, CD ROMs, DVDs, flash drives, disks, and any other known physical storage media”.

The foregoing description of the invention has been set merely to illustrate the invention and is not intended to be limiting. Since the modifications of the disclosed embodiments incorporating the spirit and substance of the invention may occur to the person skilled in the art, the invention should be construed to include everything within the scope of the disclosure.

### List of Reference Numerals

100—System for adaptive charging of a battery pack
102—Battery pack
104—One or more sensors
104a—Vehicle speed sensor
104b—Throttle position sensor
104c—Temperature sensor
104d—Pressure sensor
106—Control unit
108—Input device
200-208—Method steps

1.-14. (canceled)

15. A system for adaptive charging a battery pack of a vehicle, the system comprising:
a control unit disposed in the vehicle and that is configured to:
receive information pertaining to operating parameters of the vehicle from one or more sensors, information pertaining to grid parameters of a charging unit, and one or more user parameters from a user of the vehicle,
determine operating parameters of the vehicle based on the information pertaining to the operating parameters of the vehicle,
determine grid parameters of the charging unit based on the information pertaining to the grid parameters of the charging unit, and
determine a rate of charging of the battery pack based on at least one of the operating parameters of the vehicle, the grid parameters, and the one or more user parameters of the user.

16. The system according to claim 15, wherein the control unit is further configured to:
create a user profile of the user based on at least one of the information pertaining to the operating parameters of the vehicle and the grid parameters, and
control the rate of charging of the battery pack based on the user profile.

17. The system according to claim 15, wherein the control unit is further configured to:
determine an approximate distance of a trip upon receiving a destination location of the trip from the user, and
determine the rate of charging of the battery pack upon receiving the destination location of the trip.

18. The system according to claim 17, wherein the control unit is further configured either to:
determine topography of a route based on the route considered by the user for completing the trip, or
predict topography of the route considered by the user for completing the trip based on a previous trip of the user to the destination location.

19. The system according to claim 15, wherein the control unit is further configured to select the rate of charging of the battery pack as a fast charging during a non-peak consumption hour.

20. The system according to claim 15, wherein the control unit is further configured to suggest a time for one of:
charging the battery pack, or
schedule charging of the battery pack.

21. The system according to claim 15, wherein the control unit is further configured to control the rate of charging of the battery pack based on a power outage history.

22. A method for adaptive charging a battery pack of a vehicle, the method comprising:
receiving, by a control unit, information pertaining to operating parameters of the vehicle from one or more sensors, information pertaining to grid parameters of a charging unit, and one or more user parameters from a user of the vehicle;
determining, by the control unit, operating parameters of the vehicle based on the information pertaining to the operating parameters of the vehicle;
determining, by the control unit, grid parameters of the charging unit based on the information pertaining to the grid parameters of the charging unit; and
determining, by the control unit, a rate of charging of the battery pack based on at least one of the operating parameters of the vehicle, the grid parameters, and the one or more user parameters of the user.

23. The method according to claim 22, further comprising:
creating, by the control unit, a user profile of the user based on at least one of the information pertaining to the operating parameters of the vehicle and the grid parameters; and
controlling, by the control unit, the rate of charging of the battery pack based on the user profile.

24. The method according to claim 22, further comprising:
determining, by the control unit, an approximate distance of a trip upon receiving a destination location of the trip from the user; and
determining, by the control unit, the rate of charging of the battery pack upon receiving the destination location of the trip.

25. The method according to claim 24, further comprising one of:
determining, by the control unit, topography of a route based on the route considered by the user for completing the trip, and
predicting, by the control unit, topography of the route considered by the user for completing the trip based on a previous trip of the user to the destination location.

26. The method according to claim 22, further comprising selecting, by the control unit, the rate of charging of the battery pack as a fast charging during a non-peak consumption hour.

27. The method according to claim 22, further comprising suggesting, by the control unit, a time for one of:
charging the battery pack, and
schedule charging of the battery pack.

28. The method according to claim 22, further comprising controlling, by the control unit, the rate of charging of the battery pack based on a power outage history.
